(19) United States
(12) Patent Application Publication
(10) Pub. No.: US 2017/0076623 A1
(43) Pub. Date: Mar. 16, 2017

(54) SYSTEM AND METHOD FOR A COMPREHENSIVE INTEGRATED EDUCATION SYSTEM

(71) Applicant: Edulock, Inc., Reno, NV (US)

(72) Inventors: Patrick M Grimes, Reno, NV (US); Linda S Grimes, Reno, NV (US); Cody M Grimes, Reno, NV (US)

(21) Appl. No.: 15/361,422

(22) Filed: Nov. 26, 2016

Related U.S. Application Data
(62) Division of application No. 14/203,418, filed on Mar. 10, 2014.
(60) Provisional application No. 61/775,623, filed on Mar. 10, 2013.

(51) Int. Cl. G09B 7/02; G09B 19/00; G06Q 50/20; G09B 7/08

(52) U.S. Cl. CPC G09B 7/02; G09B 7/08; G09B 19/00; G06Q 50/20

(57) ABSTRACT

A gateway system for providing a comprehensive integrated education system. It is implemented through a cloud-computing platform, linking together learning and assessment systems, which provide learning, education, and evaluation services for a user, and reward systems, which provide rewards for a user for successfully completing learning and education processes, which are connected to the cloud-computing platform. In some embodiments, a user is a student, and a desired reward is access to certain features on the student's electronic computing device. The gateway system ensures that the student correctly answers certain test questions which have been appropriately chosen before unlocking those features.

### RELATED APPLICATIONS

The present application claims priority to and benefit from U.S. Provisional Patent Application No. 61/775,623, titled “System and Method for a Comprehensive Integrated Education System (GIES),” filed on Mar. 10, 2013. And the present application is a divisional application of, and thus claims priority to and benefit from U.S. Utility patent application Ser. No. 14/203,418, titled “System and Method for a Comprehensive Integrated Education System, filed on Mar. 10, 2014. The entire contents of the aforementioned applications are herein expressly incorporated by reference.

### FIELD OF THE INVENTION

Various embodiments of the present invention generally relate to systems and methods for motivating learning experience with rewards, including access to personal electronic devices. More specifically, some embodiments relate to integrating learning and rewards systems through cloud services.

### BACKGROUND OF THE INVENTION

Psychologists and researchers from around the globe agree that social media, for example, is highly addictive and can be similar to drug addiction. In general, a techno-addict is an individual who is addicted to the use of electronic computing devices (e.g., television, interactive video game, Internet searching, emailing, texting, chatting, twittering, etc.). As they continue staring at the screen, their physical reaction helps their brain focus on the incoming mental stimuli because of the release of the neurotransmitter dopamine that provides them a feeling of euphoria (e.g., the reward for engaging in the activity) while also driving the craving for the activity. It would be useful to focus on using this window of increased dopamine levels, along with other neurological activity generally referred to as the reward center, and hence increased ability to concentrate to enhance the individual's desire, appetite, and ability to learn new information.

### SUMMARY OF THE INVENTION

Various embodiments provide systems, methods and computer program products to optimize the learning experiences of a user, especially one with a dependency on the use of one or more electronic computing devices (e.g., cellular phones, tablets, laptops, personal computers, wearable devices, televisions, game consoles, etc.).

According to some embodiments, a gateway server which runs on or is connected to a cloud-computing platform performs the following steps. It receives a request for a reward from a client device of a user which is connected to the cloud-computing platform. It then selects one or more tasks based on a preset objective for the user and a current performance level of the user, and transmits one of the selected tasks to the client device. Next, it receives a task performance result from the client device, and evaluates the received task performance result against an expected task performance result for the transmitted task. It then determines whether the evaluation meets the preset objective. When the determination result is positive, it selects a reward for the user based on a preference of the user and delivers the selected reward to the client device.

According to some embodiments, a gateway client which is connected to a cloud-computing platform performs the following steps. It receives a request for a reward from a user, and sends the request to a gateway server which is connected to the cloud-computing platform. Next, it receives a task from the gateway server, wherein the task is determined based on an objective preset for the user and a current performance level of the user. It then allows the user to perform the task. Subsequently, it sends a task performance result to the gateway server. When an evaluation of the task performance result against an expected task performance result meets the preset objective, it receives a reward from the gateway server and presents the received reward to the user.

Notwithstanding the examples and references with an emphasis on educational learning, the system and method disclosed in the various embodiments are of particular relevance to other learning applications and conditions or third-party controlled instructions or requests such as, but not limited to, those in medical rehabilitation, hospital patients, special needs children, employees, professional groups (such as accountants, doctors, and lawyers who require annual continued professional credits), specialized training courses, athletic training, physical education, military training, trivia, pre-natal care, emergency response, farming basics, sanitation and infectious disease prevention, domestic violence awareness, and so forth.

### BRIEF DESCRIPTION OF THE DRAWINGS

The above and other features, aspects and advantages of various embodiments will become better understood with regard to the following description, appended claims, and accompanying drawings where:

FIG. 1 is a diagram illustrating an example conceptualization of integrating various components to provide optimized learning and reward experience.

FIG. 2 is an environment diagram illustrating an example environment in which different systems interact to achieve a comprehensive integrated education system.

FIG. 3 is a block diagram illustrating example components of the gateway system.

FIG. 4A is a user interface diagram illustrating an example emergency override feature.

FIG. 4B is a user interface diagram illustrating an example third-party override feature.

FIG. 5A is a flowchart diagram illustrating an example process managed by the gateway system.

FIG. 5B is a flow diagram corresponding to FIG. 5A illustrating the flow of data with respect to the parties involved.

FIG. 6A is a flowchart diagram illustrating an example process managed by the gateway system.

FIG. 6B is a flow diagram corresponding to FIG. 6A illustrating the flow of data with respect to the parties involved.

FIG. 7 is a flowchart diagram illustrating an example process managed by a user device as a client of the gateway system.

FIG. 8 contains a high-level block diagram showing an example architecture of a computer.

### DETAILED DESCRIPTION

As used herein, the term “User” refers to the person (e.g., student) whose electronic computing device, such as a cellular phone, tablet, laptop, personal computer, wearable device, television, and game console, is being controlled.

As used herein, the term “Monitor”, refers to the entity who is supervising the educational progress of the user (in the absence of a person engaging in educational self-improvement of their own volition). For example, a monitor may be a parent, an employer, a coach, etc.

As used herein, the term “Software” refers to computer program instructions adapted for execution by a hardware element, such as a processor, wherein the instructions comprise commands that when executed cause the processor to perform a corresponding set of commands. The software may be written or coded using a programming language and stored using any type of non-transitory computer-readable media or machine-readable media well known in the art. Examples of software comprise any software components, programs, applications, computer programs, application programs, system programs, machine programs, and operating system software.

As used herein, the term “Module” refers to a portion of a computer program, software or computer hardware that carries out a specific function (e.g., learning module, reward module, etc.) and may be used alone or combined with others.

### Conceptual Representation

Researchers note dopamine's presence during an event or experience helps people remember it; when dopamine is not released, nothing seems to stick. There are actually some regions of the brain, often referred to as the reward center, that increase motivation and interest in activities. The more motivated and interested one becomes with an activity the more dopamine is released and the better he remembers. The reward center helps the brain remember and repeat activities that were reinforced through positive outcomes—whether it is finding and returning to a location where good things happened or just remembering interesting information.

Separately from when the education module is introduced to a student to take advantage of the heightened learning that may exist with increased levels of the reward center, a further opportunity exists when looking at the emerging automation of education tools and on-line grading forums. For instance, programs such as Edline® make instantly available information posted by a student's teacher to the parent through an on-line system supported by a particular school or school district. However, this system by itself only makes available a particular score at a particular point in time when requested.

Precisely what is missing is an analysis of the score and insights such as trends and patterns about a student's scoring patterns. For example, perhaps the student does better with multiple choice or true false. Or perhaps the student does better when the examinations are provided directly by the text book manufacturers rather than a custom exam from the teacher. Each of these ingredients to the education recipe can be easily tracked and tabulated to provide a deeper understanding as to how the student is learning rather than what the student is learning. It would benefit the student, teacher and parent to learn how the student learns best and use that as a vehicle to propel them in their future education journeys. It is well known that many public schools teach to the common denominator for their class and different teachers possess different characteristics as well. As a result, students with tremendous potential can be lost in the process if they do not respond to the teaching techniques popular with the masses.

Speaking to the education tools, a vast opportunity exists to improve the content and the forum in which the education material is presented to students. References to multiple streams of media data are everywhere from AOL to CNN news. Further, traditional paper text books are being upgraded to include interactive elements such as the Apple® ibooks and the Pearson® etextbooks. The generation of techno-addicts is growing up with streams of information in a single place at a single point of time. The multiple streams of data create enriched learning opportunities for the education content providers to learn more about how students learn. For example, is a particular student's learning enhanced when a new topic is introduced through cognitive skills, pattern recognition skills or a combination of both? Does a student perform better when answering multiple choice questions or true false? Does the student do just as well on the final 10 questions as the first 10 questions? Answers to these questions enable a customized education platform to be introduced to the student. By focusing on how the student learns best, the teaching objective can be more easily met.

Therefore, a new method of learning is needed for students who are part of this new generation of techno-addicts (e.g., textaholics), a method that factors in a techno-student's reward center and higher dopamine levels and thus increased mental concentration for learning complex material at specific time points in relation to the use of electronic computing devices as well as one that factors in specific types of learning exercises tailored to a student's optimal method of learning.

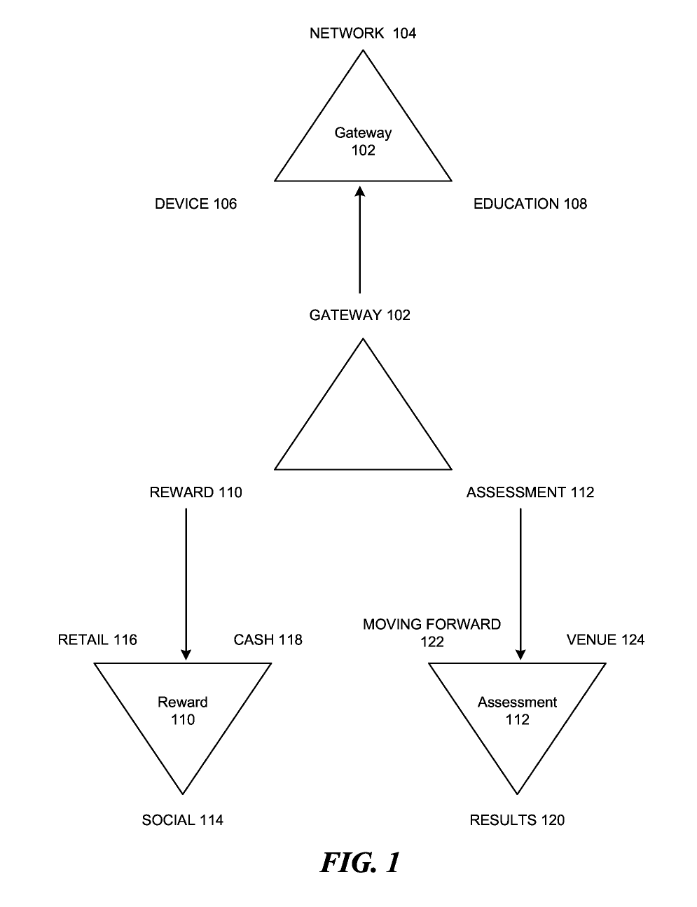

FIG. 1 is a diagram illustrating an example conceptualization of integrating various components to provide an optimized learning and reward experience. The integration relies on a gateway component 102 which links together a reward component 110 and an assessment component 112 to motivate and enhance the learning experience of users through the use of electronic computing devices and other means.

The gateway component 102 comprises systems and methods for creating a comprehensive integrated education system (GIES). It links together learning experiences offered by the assessment component 112, which may include responding to one or more educational queries, and rewards offered by the reward component 110, which may include the use of a selected feature on an electronic computing device. It also controls the flow of the linking process, whether it starts with a request from a user for a prize, the granting of which would then be postponed until a learning activity is performed as a motivation for the performance, or a request for a learning activity, which would be followed by the granting of a reward as a reward for performing the learning activity. In addition, it manages the combination of different offerings by the assessment component 112 and those by the reward component 110 to enable diverse learning-reward experiences in accordance with instructions from a user and/or a supervisor.

In some embodiments, the gateway component 102 comprises a client-server architecture where the server portion stands alone or runs on a cloud-computing platform, and clients communicate with servers via networks.

In some embodiments, the getaway component is entirely integrated into a system or a device, such as a user's electronic computing device or a network service provider system. In addition, the system may be integrated into or in communication with a rewards system and a learning and education system.

The assessment component 112 comprises systems and methods for evaluating performance statistics, providing testing and education materials, analyzing learning patterns, and so on. In terms of providing testing materials, the assessment component 112 may maintain various formats—test questions taken before a reward is given—as well as goals or other evaluations. The testing subject matter (e.g., math, history, missed test questions, etc.) and format (e.g., multiple choice, true/false, pattern recognition, etc.) may be selected by the user, the monitor, and so on. As one example, on a particular day, the student chooses the level of difficulty of the questions, the subject matter, etc. depending upon their mood, their time availability, their level of fatigue, a pending deadline (e.g., SAT test date), etc. As another example, the test questions may be chosen by a monitor (e.g., parent or the system) and depend upon: the user's performance on a test or goal administered by another (e.g., SAT grades); a user's performance over a period of time in a particular area (e.g., semester grade in a class) and/or as a whole (e.g., semester grade average for all classes). The test questions and the user's answers may take multiple formats of electronic communication: SMS texting; regular text document on a webpage or downloaded in write-over formats (e.g., Word, write-over PDF, etc.); still images; video; audio; etc.

In addition, the test materials may comprise the user accomplishing more than one task concurrently that are related in topic—such as questions and then a practical exercise. As one example, a test may involve a series of questions about how to safely operate a particular home appliance. As another example, an employer may require new or periodic training for his employees for operating equipment such as a forklift or other machinery. The test taker must answer the questions correctly and operate the appliance safely and correctly before receiving a reward.

In terms of providing education tools, which may be presented to a user before or after the presentation of test materials, the assessment component 112 may compile materials on various topics, from subjects taught and tested in school, such as English and history, to those of general interest, such as journalism and entertainment. It may further classify these materials into different difficulty levels and formats. This is an example of the venue 124 in FIG. 1. For each user, the selection of difficulty level and format may depend on the user's performance statistics, learning styles, etc. For example, for a student in the history class who has received a high score, the education materials may cover advanced subject matter with complex details, while for a student who has shown no interest in history, the education materials may cover basic topics in an easy-to-absorb format.

For instance, an “adaptive learning” element can be applied where as the student answers questions correctly, the questions (and or question types) get more challenging. Alternatively, as the student answers questions incorrectly, the questions (and or questions types) get less difficult. The “adaptive learning” can incorporate additional features such as those described elsewhere in this document pertaining to facial recognition and optical scan analyses. In these instances the electronic computing device used by the end user serves an additional purpose by measuring bio-physical aspects of the end user to enhance their learning experience. In other words, some end users may form disgruntled looks on their faces or roll their eyes when they are frustrated with the learning objective. It is an intent of this invention, among other things, to intercept the learning experience before the end user answers a question incorrectly by changing the value of reward (and thereby increasing motivation) or by decreasing level of difficulty. The same bio-physical observations can be made with reward selection and assignment and therefore the same interception strategy can be followed. Bio-physical observations include sound level detection, heart-rate, blood pressure, sleeping pattern, etc. Educational institutions, specialized learning agencies, and/or supervisors may work together towards the compilation of necessary materials based on first-hand teaching experiences or additional research.

Analytical mechanisms and optical tracking software, such as the programs created by Tobii® Technology, Inc., can provide further enhancements. The optical tracking software can be incorporated into the analytical process by which a learner is engaged in the series of questions or instructions. For example, an important analytical component could include the amount of time that the user's eyes were focused on particular questions and answers. When compared to time to answer the question the tracking of the eye over the questions and instructions would provide valuable analytical information to those familiar with the art of teaching and learning and including adaptive learning. This information would provide an important feature such as reading speed and the reading speed could be analyzed across a variety of question types and even syllable count to track reading even if the problem was related to a multiple choice question among other question types. Further, to the embodiment of this invention the reading section of question set could be separately prepared such that time could be recorded for the reading of the passage compared to the reading of the questions. In other words, does the student's reading speed change when reading background information compared to questions and answer options. Further, still, how many times does the student refer back to the reading passage? Perhaps for instance the student starts with the question and then just scans the reading passage. These patterns and more can be easily determined by those familiar with the related art.

In terms of analyzing learning patterns, the assessment component 112 may analyze how a user goes through existing learning processes and predicts effective learning processes for the user based on trends and patterns detected in the analysis. As used herein, “pattern recognition learning” refers to the ability to learn new information by a simple examination of new material. An example might be a student who memorizes the multiplication table but does not understand the relationships of the numbers. Specifically, a student might know that 7 times 6 is 42 but they may not understand the relationship of numbers. In addition, “cognitive learning” refers to the ability to learn new information by an analysis and detailed examination of new material. An example might be a student who doesn't memorize the multiplication table but understands the relationships of numbers. Specifically, a student might not know 6 times 7 is 42, but he knows that if you add (7+7+7+7+7+7) or (6+6+6+6+6+6+6) a correct answer will be achieved. This comparison of cognitive learning verses pattern recognition learning is an example of moving forward 122 in FIG. 1 wherein the system of generating questions is responding to the nature of how the student learns and providing a program that is responsive to his learning trends by subject.

As one example of analysis, the assessment component 112 may determine if a particular student's learning is enhanced when a new topic is introduced through cognitive skills or pattern recognition skills: whether the format of the new content is visual, audio or interactive; whether a student performs better when answering multiple choice or true false questions; and whether the student does just as well on the final 10 questions as the first 10 questions. As another example of analysis, the assessment component 112 may determine a user's frequency in test taking (e.g., date and time) and track the test timing to determine student's optimal performance or poor performance due to specific factors. Additional examples are as follows:
The user's time to provide an answer to a question can help identify trends such as high aptitude areas as well as weaknesses in certain question taking strategies (such as not reading all the answers provided to look for the best answer choice).
Trends to the time of day can help identify periods of the day where a user performs at higher and lower intellectual intensity.
Results from different core subjects compared together can be a useful tool in identifying learning trends and interest. For example, the fact that a user performs well in math and science but not English and history could suggest that the person learns analytical skills well.
Results for cognitive versus pattern recognition can show brain development differences, leading to new education strategies.
Results of how a user learns new information in terms of audio, visual and reading can lead to invaluable tools for enhanced learning.
Results of native knowledge, such as general understanding of physics and geography, compared with school knowledge such as chemistry, are compared to the background information provided to the person taking the question so as to provide a more accurate evaluation of the performance of the user.
Results of question types, such as multiple choice, true/false and fill-in-the-blank, can reveal test taking strategies rather than academic subject weaknesses.
Trends of the day, week or month for optimal user testing performance can be helpful in assisting a user in scheduling their academic workload and standardized testing.
Trends related to age can demonstrate correlations with maturity.
Trends related to social activities may require isolation to confirm suspicions about trends of distractions. In particular, understanding the SMS activity or social networking activity before, during and after a session could reveal disturbing trends of social distractions.
Trends related to school test dates can be conducted with a simple interface with a student's calendar. Revealing anxiety the day before a scheduled test can create opportunity for subtle time management changes.
Trends of a user compared to those of his class, school, school district, state, etc. in a particular field of study can be of great value. For example, if the questions within a Q&A system database were generated by a school district, a user could know at any particular time his competence compared to his peers.
Trends compared to results for similar subjects in a classroom could help reveal teaching/learning conflicts. For example, if the analyses showed that a user performs well on all math test questions but not well on similar subjects in school one can investigate the cause for the difference.
Trends compared to results obtained from aptitude tests such as SAT, MCAT, GMAT.

The reward component 110 comprises various forms, such as: the unblocking of a user's desired electronic device, and/or functions on the device (e.g., gaming applications, Internet access, texting, video chat); and/or other activity non-related to the use of electronic computing devices; and/or giving the user in/tangible item(s). The user may select the type of the reward, or it may be automatically designated based on the type of testing or by the supervisor. Other examples of forms of rewards comprise cash, a retailer redemption debit card, and a coupon redeemable online or at store. Further still, in an employment setting, the employee may be given a monetary bonus, extra holiday or vacation time or discounts on the employer's products and services as a reward.

Specifically, access to an electronic computing device may be controlled by different methods/entities, comprising: 1) software modules on electronic computing devices, as discussed in further detail below, which may block the use of the device until academic requirements (e.g., quiz blocking access to SMS) are satisfied; 2) network providers, as discussed in further detail below, who may block access to a user's account/device until certain performance objectives are met; 3) education module providers, as discussed in further detail below, which may block access to a student's device until grades are achieved, and 4) supervisors owning the device utilized by the user—e.g., employer-owned personal digital assistants for employee use.

A number of security options exist to block and unblock electronic transmissions from a computing device in order to for example protect the device from being used inappropriately. Methods known by someone skilled in the art comprise those for handling the following scenarios: (1) use by unauthorized person; (2) use at an unsafe time; (3) use to explore “inappropriate” applications; (4) use to abuse “appropriate” applications.

In the case of (1), use by an unauthorized person, a personalized “security password” is typically generated though the smart device's operating system through the “settings” widget under security. The password can be numbers, letters, patterns, movement or combinations. This password is designed to protect the smart device from use by an unauthorized person such as a theft but can include a curious or “snoopy” friend. The security password demonstrates what one familiar with the art could do to disable access to the smart device for periods of time that include until a target event occurs or the passage of a prescribed amount of time.

In the case of (2), use at an unsafe time, an optional setting is typically provided through the smart device's operating system through the “settings” widget airplane mode. This airplane mode is designed terminate radio communications that could interfere with the airplane communications. Examples of the specific services terminated include phone service, SMS services, email, Wi-Fi, GPS, and Bluetooth®. The “airplane mode” demonstrates what one familiar with the art could do to disable each of the individual radio communication devices or any combination thereof for periods of time that include until a target event occurs or the passage of a prescribed amount of time.

In the case of (3), use to abuse appropriate applications, access to a setting can be provided by the smart devices operating system through “settings” widget and in other cases a separate native application is required. Examples of options under settings are Guided Access from iOS 6 while options from native applications include Ap Lock and Kids Place. In addition, software packages for operating systems for smart devices like laptops, computers, etc. include “parental guidance” as a standard feature component of their operating system. The objective of these particular features is to prevent unauthorized or unintended use of specific applications of the smart device. In one case a parent may not want his child to download entertainment applications such as Angry Birds® or social applications such as Instagram® while in another example a boyfriend may not want his girlfriend to read his SMS history. The “guided access”, “parental controls” and the “native applications” demonstrate what one familiar with the art of blocking, restricting, etc. the use of a smart device's particular applications for periods of time that include until a target event occurs or the passage of a prescribed amount of time.

In the case of (4), use to abuse appropriate applications, access to the operating system separate native application is typically required. Examples of options include “parental control” software packages for operating systems for smart devices like laptops, computers, etc. as well as native applications such as MMGuardian® products and software packages known as “spyware” such as that offered by Mobistealth® Corporation. The objective of these particular features is generally to either block or restrict access for period of time, to track the activity of the user such as emails or text messages of the specific websites visited, complete or part of emails or text messages and screening such as referring to a list of blocked websites that could for example contain adult-themed material. In one case a parent may not want his son to send inappropriate pictures from the son's smart device, while in another example an employer may want to ensure that his employee is not engaged in personal social messaging when they should be investigating marketing data. The “parental controls” and the “native applications” demonstrate what one familiar with the art of blocking, restricting, monitoring, etc. the use of a smart device's particular applications for periods of time that include until a target event occurs or the passage of a prescribed amount of time.

The gateway component 102 may integrate the assessment component 112 and the reward component 110 in various ways. In one embodiment, the gateway component 102 may allow a retailer (e.g., Starbucks® Corporation) to be notified of the child's successful test results via a third party (e.g., school system educational software/service) or via the parent and deduct funds from a parent's bank account with the retailer while concurrently adding funds to their child's debit card for the retailer. In another embodiment, the gateway component 102 may allow a student to authorize an academic institution to notify the retailer via electronic communications when the student's performance results are available, and allow the retailer to reward the student with a particular product or service, a cash reward, a coupon, or a discount redeemable from the retailer or from another retailer.

As an example of the gateway component linking together an assessment component and a reward component, a device, such as a smartphone, may have an unlock application (either a native application or one downloaded through cloud services) which controls access to the device. The unlock app contacts the gateway component which instructs it whether or not the device can currently only be unlocked via correct interaction with educational content, and then displays that content to a user of the device. If the user properly interacts with the content (such as giving a correct answer to a question), the unlock app terminates its function and surrenders control of the device to the user.

The lock/unlock functionality could be programmed directly into the operating system running on the electronic device as a native application, or it could be implemented as an external, standalone application to be installed on the electronic device. The application is activated whenever the electronic device is powered up, restarted, or comes out of sleep mode. (If the electronic device has just entered sleep mode, the application may allow instant access without challenge, if the last time the device was accessed was within a certain period of time.) The application may contact the multi-layer reward module 206 via internet connection enabled by Wi-Fi or Carrier Data Plan, using a URL which resolves thereto. The application may receive a payload of information in a data packet in a common data interchange format such as XML or JSON, which contains educational content and an unlock status code (USC). The USC may instruct the application that the device is (a) un-lockable, (b) freely un-lockable, (c) un-lockable after appropriate interaction with educational content, or (d) other conditional possibilities. If access to the device is conditional {i.e. (c) or (d)}, the application will present a user interface which will prompt the user to correctly interact with it in order to unlock the device. If the interaction is correct, the application terminates after allowing full access to the device's operating system's main user interface for accessing the device's functionality. If the interaction is incorrect, the application will process certain logical conditions which may allow second chances to interact correctly with educational content, optionally after a certain wait period, and/or allow visual and/or auditory access to learning content prior to answering again, and/or give second chances at new content, or completely block access, or other logical possibilities.

In some implementations of the invention, the content and/or conditions of unlocking and/or restrictions and/or conditions and/or rewards given for correct interaction, may be accessed from other third party Internet connected devices or monitor devices, which enables authorized users to specify content, restrictions, rewards, and so on (collectively “establishing the unlocking criteria”).

A parent may use their third party device to make a request to the gateway component through the cloud services for their child to answer a math question such as 4×4. The gateway component then sends requested answer to the child's electronic device through the cloud services. Once the answer is input onto the device by the child, the input is processed from the child's electronic device, and the information is sent back to the gateway component, which will then send the answer back to the third party device, in this case identified as the parent.

The gateway component 102 may utilize location information of a user determined via, for example, the global positioning system (GPS) capabilities of the user's electronic computing device, in integrating the assessment component 112 and the reward component 110. As one example, the gateway component 102 may require a user to go through a learning process involving a physical task (e.g., running around the neighborhood, walking home from school at certain time and route) that is tracked by the user device before receiving a reward. As another example, when a student walks into a mathematics class in school five minutes before class starts and wants to chat online, the gateway component may require that the student first pass a test comprising math-themed questions chosen by the teacher. In a commercial setting, a customer at Starbucks® store or website might be asked a series of questions about the nutritional value of his most recent purchases. Further still, in an employment setting, the employee may be asked a series of questions about laboratory safety or emergency exits as they move from one plant to another.

The three components conceptually form a triangular relationship. Each of them further supports a unique three-fold structure. For the gateway component 102, the three-fold structure reflects how the gateway component 102 is typically implemented, namely by network providers 104, control component makers for electronic computing devices 106, and education providers 108. These three parties often have direct connections to the assessment component 112 or the reward component 110, which makes them good candidates for implementing the full range of gateway functions.

The network providers 104 comprise commercial entities providing services to wireless and digital electronic computing devices, such as Vodaphone® Group Pie, AT&T® Inc., Verizon® Communications Inc., etc. The network providers 104 may control the network connectivity and data usage of electronic computing devices, and their products and services may incorporate the gateway component 102. For example, when a parent signs up for a wireless plan, he may specify performance objectives, skills to be improved, and rewards to be earned for his child as part of a service agreement, and the wireless company as a network provider 104 may utilize the gateway component to communicate with education providers 108 and retailers 116 to be discussed later, for examples, and streamline the learning-reward process for the child.

The control component makers 106 for electronic computing devices comprise software writers and hardware manufacturers for personal computer devices such as cellular phones, smart phones, electronic tablets, laptops, desktops, interactive televisions, tablets, smartphones, personal digital assistant devices, game consoles, computerized toys and robots, media players, wearable devices, etc. A non-limiting example of device manufacturers comprise: Dell® Inc., Toshiba® Corporation, Hewlett-Packard® Company, Apple® Inc., etc. The control component makers 106 may control the data usage and application usage of electronic computing devices, including access to various social media, and their products and services may incorporate the gateway component 102. For example, after a parent purchases a cellular phone, he may input performance objectives, skills to be improved, and rewards to be earned for his child into a control component that is part of the operating system running on the cellular phone or a subsequently installed application, and the control component may utilize the gateway component 102 to communicate with education providers 108 and retailers 116, for example, and streamline the learning-reward process for the child.

A control component may comprise a native application, a web application, or a widget type application to carry out the methods of graphically displaying the age (i.e., the duration since the last viewing) of content on a computing device screen. A native application may be pre-installed on the device or downloaded from the Internet. It may be written in a language to run on a variety of different types of devices; or it may be written in a device-specific computer programming language for a specific type of device. A web application may reside on a system server and is accessed via the network. It performs basically all the same tasks as a native application, usually by downloading part of the application to the device for local processing each time it is used. The web application software may be written as Web pages in HTML and CSS or other language serving the same purpose, with the interactive parts in JavaScript or other language serving the same purpose. Or the application can comprise a widget as a packaged/downloadable/installable web application, making it more like a traditional application than a web application, but like a web application it uses HTML/CSS/JavaScript and access to the Internet.

The education providers 108, who may also implement part or all of the assessment component 112, comprise academic institutions and other education system providers such as Edline® LLC, Mindflash® Technologies, Inc. and Knoodle®, Inc. The education providers 108 may control learning and education processes of a user, and their products and services may incorporate the gateway component 102. For example, when a parent signs up for a testing and evaluation system, he may specify performance objectives, skills to be improved, and rewards to be earned for his child as part of a service agreement, and the education providers 108 may utilize the gateway component 102 to communicate with retailers 116 and network providers, for example, and streamline the learning-reward process for the child.

For the reward component 110, the three-fold structure reflects what types of rewards are typically desirable, namely access to social media 114, earning cash 118, and receiving retail credits 116. The social media providers offer a wide range of personal connectivity options, such as Facebook®, Linked In®, Match.com®, Skype®, instant messaging, inter-active gaming like 4 Dimensions® and Avalon®, texting, etc. The social media providers 114 serve an important role of providing an intoxicating and seductive platform for social interactions under different compensation arrangements from free, fee-for-service to fixed monthly plans. The retailers 116 offer prepaid cards, or coupons, free services, and other forms of credit and value to be used in stores or online. Cash providers 118 are typically monitors of the users, who may present cash, issue a check or authorize bank deposits to the user.

For the assessment component 112, the three-fold structure reflects what types of data could result from learning assessments, namely results 120, venues 124, and moving forward 122. The educational results 120 (grading feedback) include the measured results associated with the user's academic performance, which may be expressed in terms of a percentage, a numerical grade, etc. The educational results 120 are typically measured in a range of methods from student-written essay, multiple choice, true false, completed in handwriting, Scantron forms and combinations of the same. The educational venues 124 (method of learning) include an analysis of the measured results by among other things cognitive and pattern recognition testing and evaluation. The educations venues 124 serve an important feature in evaluating learning patterns that identify strengths and deficiencies. The education strategies (working with results) moving forward 122 give the user the ability to decide how they want to learn, such as by practicing weak areas or maximizing performance in strong areas. In other words, an action plan for personalized learning is developed after an analysis of the results.

The various embodiments may be better understood by referring to FIG. 1 below in conjunction with Examples 1-8 infra. The following examples are used to demonstrate the variability that is available within the GIES system. In particular, it reveals how the various combinations enable a flexible formula for education success.

### Example 1

### Home Schooled Student Supplementing Core Curriculum

A home schooled elementary student elects to use a smartphone (FIG. 1, device 106) as the gateway to a supplemental exercise for a core curriculum course. The device has Internet connectivity to download a mobile application comprising the lesson, or for her to visit the system's website to complete a learning exercise comprising a 30 geography lesson. She also selects that her performance on the learning module be assessed with objective test results (e.g., multiple choice questions generated by the system) (FIG. 1, results 120). And for her reward she selects to receive cash from her parents (FIG. 1, cash 118). Upon successful completion of the test, the parents are sent an electronic message by the system, such as a text or email indicating the amount they owe their child, and a copy of the test results, time taken, etc. The parents can pay their child in cash, or they can elect to credit their child's financial account, the latter of which can be setup automatically on their system account. When the system determines every time the student has met a preset objective, their credit card automatically receives a transfer from the parent's account (on the system, or on a separate financial account). Alternatively, every time the system notifies the parent that their child has met a preset objective, the parent must log into their system account and process the transfer of funds to their child, which can be a one-click payment process step using stored financial account information.

### Example 2

### A High School Student Selecting Grade Criteria and Eliminating Parent Policing

A traditional high school student elects an education gateway (FIG. 1, education 108 wherein he informs his school's guidance counselor via an online message to have all his teacher's online grades interlinked with a disabler function for his social media connections. He selects objective grading criteria such as his accumulated grade point average maintaining at least a 3.5 in each individual class (FIG. 1, results 120). If he does not earn a pre-designated grade for each class, then he cannot access his online social media accounts (e.g. Facebook®) from his electronic computing device that is registered and recognized by the school's online grade reporting system. For his reward he selects a retail reward (FIG. 1, retail 116) comprising a gift certificate at a Starbucks® store or website (and includes a discount as an acknowledgement from Starbucks Corporation for his performance).

### Example 3

### A Student Preparing for the SAT by Focusing on Test Weaknesses

An SAT preparation student elects to use an electronic computing device as the gateway where, for example, she can access a pre-existing feature on her cell phone (e.g., text messaging) (FIG. 1, device 106). She selects the education venue where, for example, she receives feedback on cognitive portions of academics (FIG. 1, venue 124). She also choses to have the feedback provide her with specialized questions that improve her noted weaknesses. For her reward she selects access to her Twitter® social media account for a set period of time (FIG. 1, social 114).

### Example 4

### Person Engaging in Self-Improvement of Intellect

A person studying a second language as a hobby elects to use the network as the gateway where, for example, he informs his Internet and/or cellular service provider to only enable his critical communications after achieving specific targets on his second language modules (FIG. 1, network 104). He selected the education venue where, for example, he could have selected feedback on pattern recognition portions to improve his language vocabulary (FIG. 1, venue 124). For his reward, he selected social media where he could have selected LinkedIn® time (FIG. 1, social 114).

### Example 5

### Patient Reducing Brain Deterioration with Customized Mental Exercises

A medical-dementia patient elects to use the network as a gateway where, for example, she informs AT&T® Inc. to only enable her critical communications including satellite television until after she achieves specific targets on brain exercises (FIG. 1, network 104). She selects the education venue so that she could identify the precise elements of her brain between cognitive and pattern recognition that were further diminished (FIG. 1, venue 124). These areas then become the priority in her daily exercises. For her reward, she selects retail such as a meal at Denny's® restaurant (including the senior citizen discount for mental game progress) (FIG. 1, retail 116).

### Example 6

### Executive Inducing Creative Uninterrupted Brainstorming

A corporate executive elects to use the network where he informs AT&T Inc. to enable only his critical communications (e.g., laptop, PDA) until he achieves his targets on his blank paper brainstorming sessions (FIG. 1, network 104). He selected education strategies moving forward so he could work on improving his strengths (FIG. 1, moving forward 122). For his reward he selects social media comprising social time on an interactive golfing game (FIG. 1, social 114).

### Example 7

In the example of the home school elementary student, she selected to use the computational device as the gateway where, for example, she could have downloaded a cell phone application. For her reward she selected cash whereas for her assessment she chooses to go with objective results such as a percentage score on her performance with a 30 geography application that could have been downloaded (FIG. 1, Education 108).

A highly motivated SAT student who is looking to improve his already near perfect score might select a program whereby he selects an individual weakness to develop on his personal computer (FIG. 1, device 106). In other words, he is trying to improve on his specific weaknesses as identified in individual sections of the exam. He may also seek a pay as you go reward method that provides both a social media reward (FIG. 1, social 114) and cash (FIG. 1, cash 118). He may likely even prescribe the method of learning that is most agreeable to mastering his weaknesses. In one case, he goes with combination of cognitive and pattern-recognition as the method of learning. The feedback is clear because SAT is a number score (FIG. 1, results 120). The gateway for the student would likely be something that he downloads from the internet directly to his primary device. The notion with the motivated SAT student is that he does not require multiple layers of reinforcement and restrictions to guide him. In fact, he is expected to gravitate to GIES because he will show an improved method of learning which will enable him to more efficiently achieve his objective of a perfect score on SAT.

### Example 8

In an example where a less motivated SAT student is looking to improve her overall score, she might select build on her strengths and develop her weakness on her tablet (FIG. 1, device 106). In other words, she is trying to learn how she can improve her overall score so she needs to first learn what are her strengths and weaknesses and then decide how to allocate her efforts. To this end, unlike the motivated SAT student, she will likely go with individual exams rather than narrow sections of exams. She may also select a pay as you go method because she has little interest in studying when she has no immediate reason to do so. Like the motivated SAT student, however, the feedback is clear with quantified number result (FIG. 1, results 120). The gateway for the student would likely be something that combines a series of securities to ensure that the student is not able to override any systems. So she could, for example, select a combination of a network provider and a software download (FIG. 1, network, 104 and education 108).

### Environment Architecture

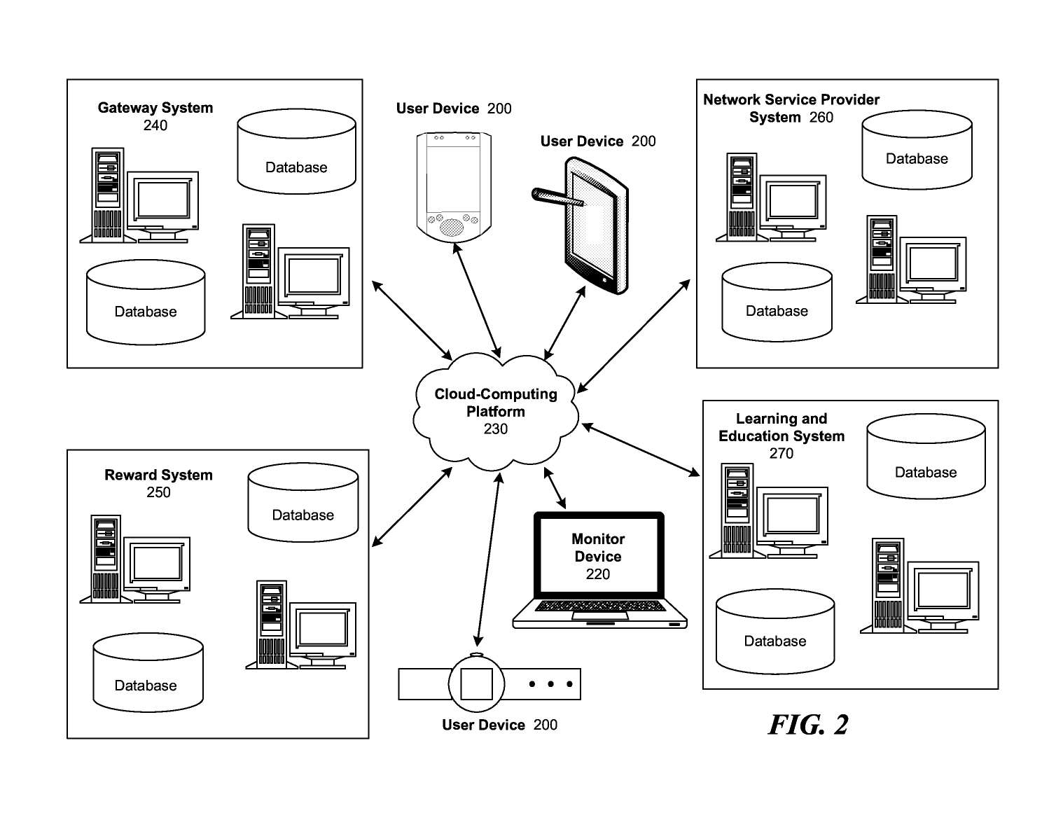

FIG. 2 is an environment diagram illustrating an example environment in which different systems interact to achieve the GIES. The gateway system 240 or the server portion thereof may reside on the cloud-computing platform 230, making its functions readily accessible by other systems that are connected to the cloud-computing platform 230, which may include the user device 200, the monitor device 220, the network provider system 260, the learning and assessment system 270, and the reward system 250.

In some embodiments, the cloud-computing platform 230 represents a family of services hosted on one isolated server, multiple isolated servers, or on distributed servers that virtually appear to clients to be a single server. It is isolated or divided onto isolated different servers to facilitate the isolation, organization, and management of diverse families of functions that may be accessed by some authorized parties but not others. As one example, the services that may be utilized by the assessment system 270 may be hosted on one server. As another example, the services for submitting new education and testing materials by the monitor device 220 and the services for dispersing such materials to the user device 200 may be hosted on separate servers. In order to properly function, these separate servers may need to privately share information with each other via messaging and application program interface (API) calls, via common interfacing, and messaging techniques known to those skilled in the art.

In some embodiments, the gateway system 240, or at least the server portion, may stand alone and communicate with the network provider system 260, the learning and assessment system 270, and the reward system 250 through their APIs, to simplify change and maintenance, for example. In some embodiments, the gateway system 240, the server portion, or the client portion may be integrated into some of these other systems to reduce network traffic, for example.

A user device 200 is a user's electronic computing device with web browser capabilities configured to communicate with the gateway system 240 via the cloud-computing platform 230 or otherwise through networks, which comprises any public network such as the Internet or World Wide Web or any public or private network as may be developed in the future. It is the means by which the user participates in the CI ES. It may receive and respond to educational/testing modules provided by the learning and assessment system 270, reward data provided by the reward system 250, and other modules and data loaded into its memory. The monitor device 220 is a monitor's electronic computing device with web browser capabilities configured to communicate with the user device 200, or with the gateway system 240, through the cloud-computing platform 230 or otherwise via networks. The user device 200 and monitor device 220 may connect to the network via a variety of methods such as a phone modem, wireless (cellular, satellite, microwave, infrared, radio, etc.) network, Local Area Network (LAN), Wide Area Network (WAN), or any such means as necessary to communicate to a server computer connected directly or indirectly to the network.

In some embodiments, the user device 200 and the monitor device 220 are one in the same electronic computing device with the client portion of the gateway system 240 installed thereon. The client portion enables the monitor to select and/or review the activity of the user in practicing educational modules. The monitor's access to the educational modules may be protected by a security feature (e.g., login credentials) to permit the monitor to select which educational modules for the user to practice and the approved solutions (e.g., answers) for the modules.

In some embodiments, the user device 200 has the client portion or the entirety of the gateway system 240 installed to enable the user to practice test/educational modules and/or to enable the user to receive rewards 110 upon a satisfactory practice. As one example, the client portion may have the device blocked with direct control or through a network service provider. Upon a successful completion of the modules, the client portion then permits the blocking of the entire user device 200, and/or particular features (e.g., Internet access or texting capabilities) of the user device 200. As another example, if the user has elected to receive cash and/or deposits to their credit or debit cards from the monitor, the user device 200 may communicate successful completion of the educational module directly with the monitor device 220 or through the gateway system 240, which may then notify the monitor device 220 of the reward due. The cash transactions may be accomplished by using PayPal® services or Amazon Coins, for example.

### Gateway Modules

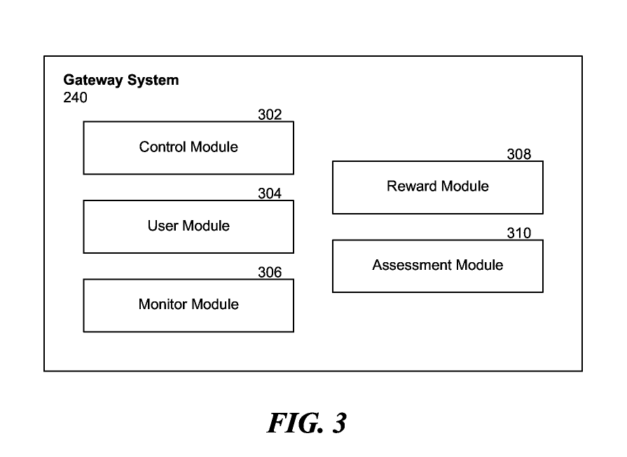

FIG. 3 is a block diagram illustrating example components of the gateway system 240. In some embodiments, the gateway system 240 comprises a control module 302, a user module 304, a monitor module 306, a reward module 308, and an assessment module 310.

In some embodiments, the control module 302 manages performance objectives used to determine whether the result of a user's learning process is satisfactory enough for a reward to be given. It may accept an initial set of performance objectives and further updates from a user or a monitor. The control module 302 also determines a user's testing and education materials based on various factors, including the user's current performance level, the preset performance objectives, the user's learning styles, and the user's current time and location, which can often be used to decide the subject matter of the materials. As one example, when a student requests to visit a specific website using his cellular phone in a history classroom, as indicated by the GPS coordinates captured by his cellular phone, the education and testing material could comprise a set of history quizzes, the format of which depends on the user's preference and the difficulty of which reflects the student's score on the last history test. As another example, when a user indicates his intent to engage in a self-improvement process at six o'clock in the morning, the education and testing material could comprise a map of a jog route and a set of questions regarding certain signs along the jog route to be observed by the user. In this instance the electronic computing device could come in the form a wearable such as a fitness ban. In addition, the control module 302 determines the rewards for a user based on various factors, including the user's and the monitor's preferences, the participating retailers' offerings, and the user's current time and location. As one example, when a user is located in a coffee shop, the reward could be a gift card issued by the coffee shop. As another example, at five minutes before a student's next class, the reward could be access to social media for five minutes.

In some embodiments, the control module 302 also handles exceptions. For example, it may allow a user to receive a reward without completing a learning process. When the reward is access to the user's electronic computing device, the control module 302 offers such exception handling by allowing the user to override the default access blocking in emergency situations. For example, by inputting in a preset code into the device, the user can gain limited access to the device to place an emergency call (e.g., VoIP to emergency responders or to a third party associated with their account on the system server); or to gain access to email, text, instant messaging, or the like functionality on the device for transmission of electronic communications to designated contacts (e.g., mobile numbers for calls or texts, email addresses, etc.). The code for overriding access blocking may be a personal code designated by the user, or it may be a universal code for all users of the gateway system 240. The code may also be input into the device via keystroke, touch input to a touch screen, or audio input. Additionally, every instance of the user's emergency override may be recorded and electronically conveyed instantly to the monitor affiliated with the user's record.

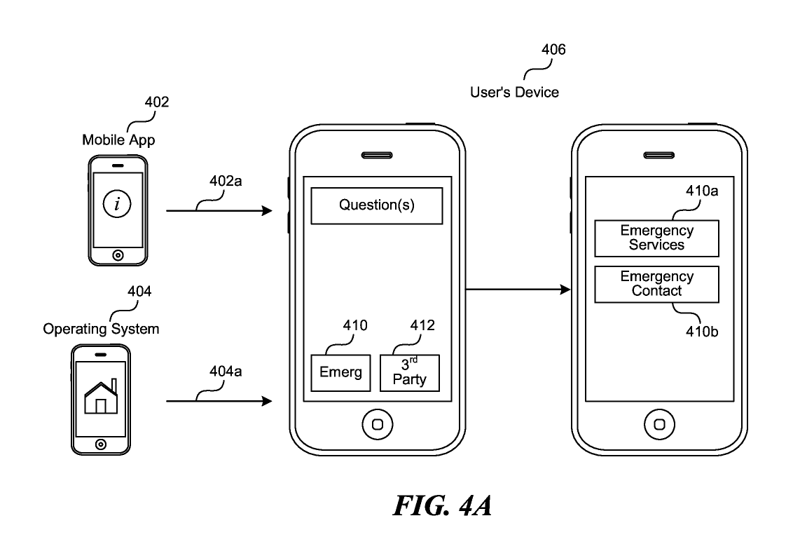

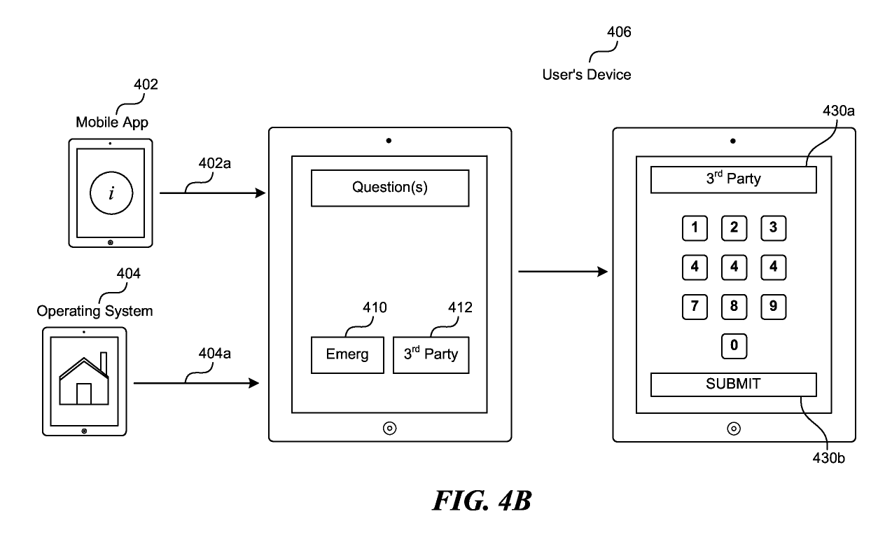

FIGS. 4A and 4B are diagrams illustrating an instant override feature. In each case, the override provides for bypass of the learning modules so that the device can be used for emergency contacts or the device can be used by a third party in such a manner that the user is not forced to respond to the education content. FIG. 4A is an user interface diagram illustrating an example emergency override feature that can be requested by pressing the button 410 on the user's electronic computing device, for example, but those well-versed in the art will understand multiple alternatives are available. The emergency override feature may be downloaded as an external application 402 via a network connection 402a or incorporated into the operating system 404 via a device installation means 404a. The emergency feature allows the end user to select two options. Option one is the emergency services that may be requested by pressing the button 41 Oa, for example, which connects the user to the local authorities such as fire or police or 911. Option two is the emergency contacts feature that may be requested by pressing the button 41 Ob, for example, which allows the user to select and contact a predetermined emergency contact list such as parents and friends. This emergency override system connects to emergency services that are offered by the various network providers for smart phones, such as AT&T® Inc., on a standard basis.

FIG. 4B is a user interface diagram illustrating an example third-party override feature that may be requested by pressing the button 412 on the device, for example, but those well-versed in the art will understand multiple alternatives are available. The third-party override feature may similarly be downloaded as an external application 402 via a network connection 402a or incorporated into the operating system 404 via a device installation means 404a. The third-party override feature allows a third-party user to enter a custom four digit passcode via the field 430a and submit the pass code via the field 430b, which unlocks the user's electronic computing device to its normal functionality. For instance, a parent may share a mobile phone with a child and want to use the phone without answering questions to unlock the mobile phone. The parent would select the third-party override feature, enter the known four digit passcode, and then submit the answer.

In some embodiments, the user module 304 communicates with a user and the user device 200. It accepts data from the user, such as a request for a reward, answers to test questions, and learning and reward preferences. It also outputs data to the user, generally, such as test questions and reward information. In addition, it sends notifications to the user, such as when an update or an error occurs. For example, it may inform the user when a monitor updates the performance objectives or when a retailer offers coupons on new products.

In some embodiments, the monitor module 306 communicates with a monitor and the monitor device 220. It accepts data from the monitor, such as the performance objectives, education and testing materials, information on allowed rewards, and a specification of areas for improvement for the user as well as information regarding the user's and the monitor's bank accounts. Further examples include information on the number of minutes that may be spent on the user device 200, which applications may be used, how often and/or when, how much testing material must be interacted with correctly, how much education content must be viewed and for how long, and which action should be taken in case the testing material is incorrectly responded to. The monitor module 306 also sends notifications to the monitor, mainly to update the monitor on the user's progress. For example, it may inform the monitor when the user requests a reward, starts a test, finishes a test, and receives a reward, along with further information on the nature of the request, the performance on the test, and the nature of the reward.

In some embodiments, the assessment module 310 communicates with the assessment system 270. It accepts data from the assessment system 270, such as education and testing materials and learning analysis results for a user. It also outputs data to the assessment system 270, such as education and testing materials prepared by a monitor, requests for specific education and testing materials from a user, answers to test questions from a user, and statistics regarding a user's learning process.

In some embodiments, the reward module 308 communicates with the reward system 250. It outputs data to the reward system 250, such as a user's or monitor's reward preferences and choices. It also accepts data from the reward system 250, such as information on retailers' offerings and distributed rewards.

### Gateway Process Flows

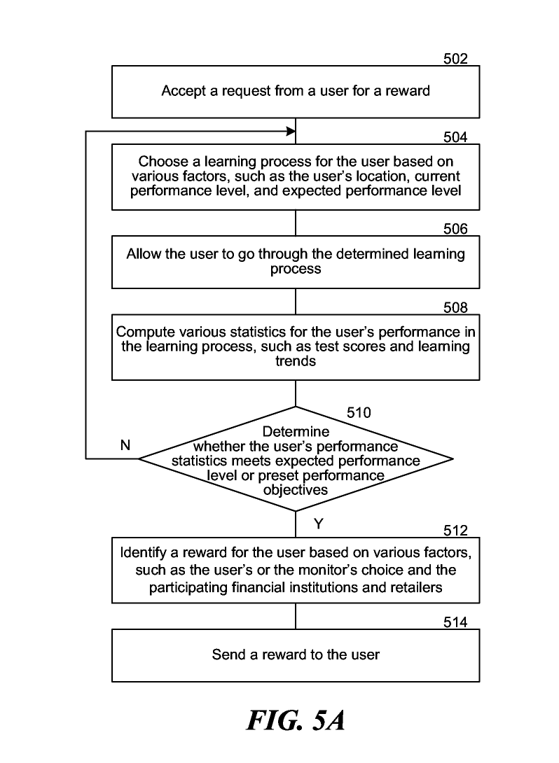

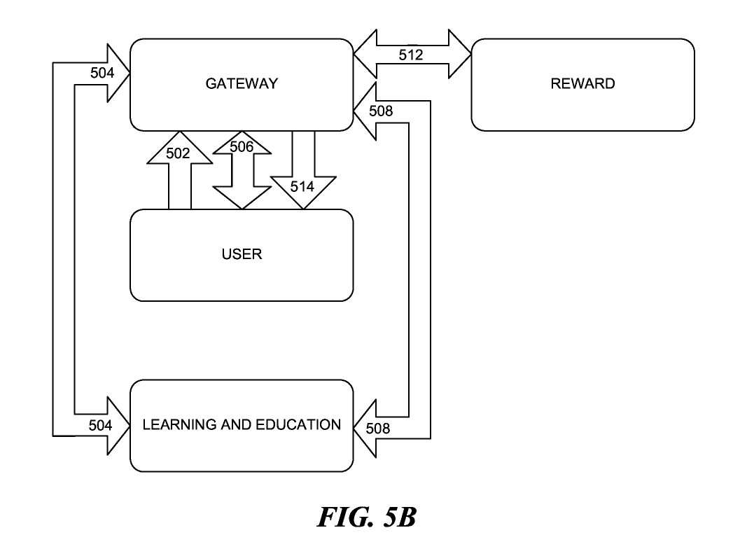

FIG. 5A is a flow diagram illustrating an example process managed by the gateway system 240, and FIG. 5B is a corresponding flow diagram illustrating the flow of data with respect to the parties involved. At step 502, the gateway system 240 accepts a request from the user device 200 for a reward, which may be access to specific features or functions of the user's electronic device. The user device 200 may have a client portion of the gateway system 240 programmed directly into its operating system or installed as an external application. It may transmit the request in response to the user's attempt to access certain functions on the user's device or otherwise perform an activity of the user's interest through the user device 200. Specifically, when the requested reward is access to any native features of the user's device, the request may be transmitted whenever the user's device is powered up, restarted, or comes out of the sleep mode. At step 504, the gateway system 240 chooses a learning process that the user needs to complete before receiving a reward, in terms of subject matter, format, duration, etc. It may choose a learning process most appropriate for the user at the time based on a variety of factors, including the user's current performance level, the user's expected performance level, and the current time and the user's location. The learning process is not limited to academic themes and may include physical exercise, rehabilitation, physical education and the like. Generally, the gateway system 240 works with the assessment system 270 in providing the user with an appropriate learning process. For example, it may obtain a user's test scores on a specific subject and the user's daily class schedule from the user's education institution in advance. Upon choosing a learning process for the user, the gateway system 240 requests and receives the corresponding education and testing materials from the assessment system 270. At step 506, the gateway system 240 sends the education and testing materials to the user and receives the corresponding replies. For example, a series of questions may be presented to the user in a graphical interface that allows the user answer the questions using the buttons on the user device 200. The activation is not limited to physical connections and may include audio, optical tracking, gestures of the users limbs, movement of the electronic device and the like. At step 508, the gateway system 240 sends the user's replies as well as related performance statistics in terms of timing, location, and other variables to the assessment system 270, and receives the user's performance evaluation and learning trend analysis from the assessment system 270.

At step 510, the gateway system 240 compares the user's performance evaluation result with the preset performance objectives. When the user's performance evaluation result meets the preset performance objectives, at step 512, the gateway system selects a reward for the user. It may select a reward most appropriate for the user at the time based on a variety of factors, including the user's and the monitor's preferences, the participating banks and retailers' offerings, and the current time and the user's current location. Generally, the gateway system 240 works with the reward system 250 in providing the user with an appropriate reward, which may or may not be the reward initially requested by the user. For example, the gateway system 240 may receive a list of merchant offerings and their effective dates from the reward system 250 in advance. Upon selecting a reward for the user, the gateway system 240 requests and receives the reward or related information from the reward system 250. As an example, the gateway system 240 may receive an authorization of accessing specific features of the user's cellular phone, in which case it may send an instruction to the cellular phone to unlock those features. As another example, it may receive information regarding a retailer's gift card, in which case it may forward the information to the user. However, when the user's performance evaluation result does not meet the performance objectives, at step 504, the gateway repeats the process starting from choosing another learning process for the user. The gateway system 240 may take other options, such as notifying the monitor after a certain number of unsatisfactory performance results, seeking additional input from the monitor on the learning process for the user before choosing the next one, etc. In this manner, the gateway manages a user's learning and reward experiences without requiring a monitor's interference during the process.

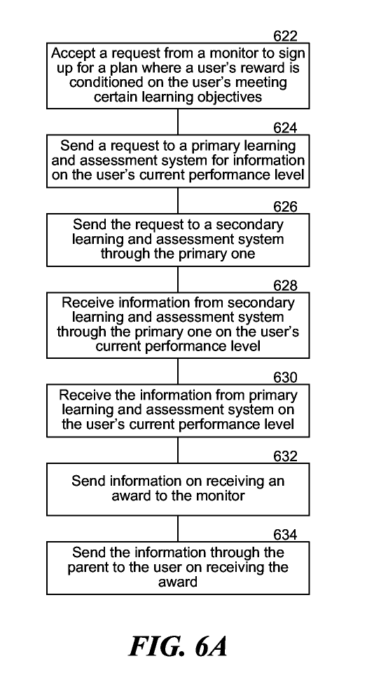

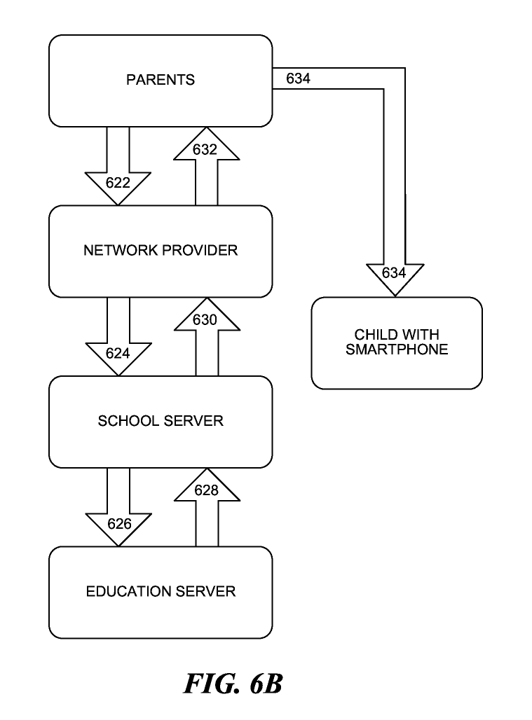

FIG. 6A is a flow diagram illustrating an example process managed by the gateway system 240, and FIG. 6B is a corresponding flow diagram illustrating the flow of data with respect to the parties involved. In this illustration, the gateway system 240 is integrated into the network provider system 260. At step 622, in response to a monitor's request, the network provider system 260 opens an account for a user's electronic computing device. The request may be submitted by the monitor in person at a network provider's service center, telephonically, or via an online website account using the monitor device 220. While opening an account, and any time thereafter, the monitor may indicate, as terms of an account agreement, the parameters or conditions that their user must meet in order to receive certain rewards, especially access to specific features and functions on the electronic computing device. For example, the monitor may set that the user may only have access to the device's Internet functionality if the user earns an “A” on the user's mathematics midterm examination. The monitor may also set time limits for access, or the duration of access may be unlimited after the performance objectives are met. The network provider system 260 would then enforce the terms of the account agreement. It is readily apparent to someone of ordinary skill in the art how to apply the same steps when the gateway system is integrated into other systems. For example, in lieu of a parent directly authorizing a network provider to control a student's device, the parent could contract with an education service, such as Edline® LLC, a device manufacturer, such as Nokia® Corporation, or a retailer as well as connections made from fitness bands, wearables that account for activity directly on the device and via cloud.

At step 624, the network provider system 260 connects via the Internet to a primary learning and assessment system, such as the child's school. It has previously received authorization from the monitor and the primary learning and assessment system to access information on the user's academic performance. At step 626, the primary learning and assessment system examines the data it has on the user and connects with a secondary learning and assessment system, such as third-party education software service provider Edline® LLC, to obtain further data on the user, such as a student's grades submitted by teachers or school administrators. At step 628, the primary learning and assessment system retrieves information on the user's current performance level from the secondary learning and assessment system. At step 630, it electronically transmits the information to the network provider system 260. The primary learning and assessment system or the network provider system 260 may also conduct certain analysis of the student's academic performance.

At step 632, the network provider system 260 determines whether the user's current performance level meets the conditions specified in the account agreement. For a positive determination, the network provider system 260 transmits to the monitor information on the user's current performance level and on a reward. At the same time, it transmits the reward or relevant information to the user. In this case, since the user's current performance level already meets the performance objectives, the user would not be required to go through a learning process before receiving a reward, such as access to certain features of the user's electronic computing device. At step 634, the monitor forwards the information on receiving the award as well as the performance objectives to the user to remind the user to keep up with the performance objectives or the rewards would no longer be readily available in the future. In this manner, the monitor may rely on the network provider system 260 to play an active role in the user's learning and reward experiences but would stay informed of the user's progress.

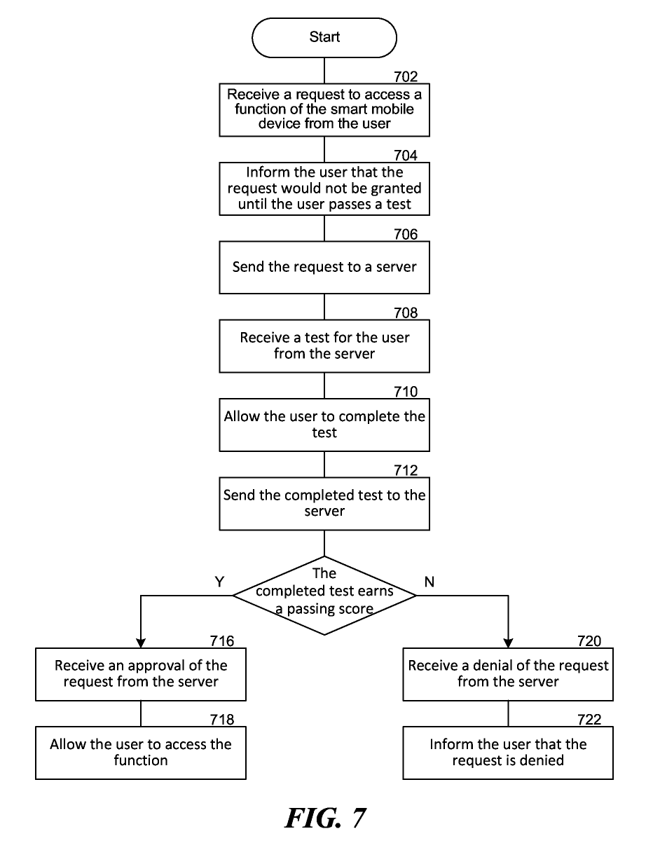

FIG. 7 is a flowchart diagram illustrating an example process managed by a user device 200 as a client of the gateway system 240. Initially, access to all the functions of the user device is blocked. At step 702, the user device 200 receives a request to access a function of the user device from the user. The function could be allowing the user to make a phone call, play a game, etc. At step 704, the user device 200 informs the user that the request would not be granted until the user passes a test or completing a task or following an instruction such as clean a room or complete a chore or other task (at work, home or school). The test could be selected based on the user's learning objectives and current performance level. At step 706, the user device 200 sends the request to the gateway system 240. At step 708, it receives the selected test for the user from the gateway system 240. At step 710, it allows the user to complete the test or the request to follow an instruction such as command for exercise. At step 712, it sends the completed test to the gateway system 240, which would then evaluate the completed test and generate a corresponding score. When the score is a passing score, at step 716, the user device 200 receives an approval of the request from the gateway system 240, and at step 718, it allows the user to access the function as requested. When the score is not a passing score, at step 720, the user device 200 receives a denial of the request from the server, and at step 722, it informs informing the user that the request is denied. In an alternative embodiment this could all be done locally or on a native level of the electronic computer device.

### Alternative Implementations

In one implementation, all education and testing materials are preloaded in the persistent data storage on the user device 200 that is associated with the gateway system 240 or the client portion thereof integrated into the device, such that it is not required to access the cloud-computing platform 230 to obtain such content or reward 250.

In one implementation, all education and testing materials are pre-cached in the persistent data storage, such that periodically, the integrated gateway system 240 preloads data that is ready on hand for instant on-device access when needed. This circumvents problems that may occur when device internet connectivity is absent or problematic and increases speed and performance of unlocking. This preloading may occur in two ways: (1) Periodically, the integrated gateway system 240 may check for updates to preloaded education and testing data as a terminate and stay resident (TSR) process. (2) At each use, the integrated gateway system 240 may check to see if it needs to update its preloaded data, which it will then fetch and have preloaded for future uses.

In one implementation, one, many, or all of the servers of the cloud-computing platform 230 are controlled by the network provider system 260. Any attempt to access a mobile data plan, SMS or MMS texting services, or telephony services offered by the network provider system 260 will be regulated by the servers and infrastructure of the network provider system 260, which may communicate with the servers of the cloud-computing platform 230 using internal server APIs.

### Sound Level Control

A voice decibel mechanism that will shut down the software system (or otherwise modify the reward portion or the earning portion if the electronic device detects a sound emitted from the user (or from the smart device itself) at a level higher (as measured in decibels) than a pre-set (or personalized) limit. One familiar with voice decibel systems and the widely available applications to record and detect the decibel level from the electronic device would understand the manner in which the hardware of the electronic device already contains the detection and measurement equipment. In particular, the U.S. patent application Ser. No. 13/568,950 describes many of the features capable of being monitored by the electronic device. This feature disclosed in various embodiments may be particularly useful in a classroom setting where one student might be enjoying a privilege he earned by playing a game while another student is still earning time. In other words, in a classroom setting, when the student is enjoying their reward, he may elect to play a game such as Angry Bird. If the student had the volume too high or was laughing too loud the sound level control would intercept the session. However, any other environmental settings where the sound level is concerned are relevant as well.

Optionally, in one example, the sound level control could simply remove some or all of the time that was earned during session with this invention if a sound level exceeded the established threshold. Further, the sound level control could send out a warning, in the form a dropdown message (like a banner add) before taking an action of shutting down or removing time. In the case of the volume of the device exceeding the established limits the device could adjust itself to the appropriate level or simply eliminate its sound emitting capability for a specific time, or event such as use of a particular application or function. Alternatively, the sound level detected by the electronic device could be used to measure the excitement of the end user engaged in the learning objective. For example, a person excited about completing a module could exert sounds of exhilaration. Conversely, someone frustrated with the learning experience could exert grunts of frustration. One familiar with the art of language and human sound could understand the nature of the differences of the sounds and their implications on learning.

### Special Needs Population

It is also noted that the features discussed in various embodiments of this invention are suitable for use in a variety of situations beyond parent/child and teacher/student, such as by employers training employees, clinicians engaging in rehabilitation of patients who are mentally impaired, etc. For example a child with autism could be provided with educational content on basic hygiene routines, while an adult with Alzheimer's could be provided with education content on family history. The features of this invention may also involve self-monitored learning by an individual who has elected to master a new subject (e.g. foreign language) or exercise their intellect (e.g. memory and analytical exercises for an aging individual). In this scenario, the individual would function as both the system “user” and “third party” by selecting the scope of access denied to the device, such as the entire device or the Internet, or the Facebook® website, etc.; and being provided the analyzed results of their progress directly from the system server.

In another example the electronic device could be used for monitoring the movement via a range of electronic devices such as a smart phone, smart watch or smart glasses. A movement in a targeted motion or position that is part of a learning or training program would be rewarded by providing expanded or full functionality of targeted electronic device(s).

Notwithstanding the examples and references with an emphasis on educational learning, the system and method disclosed in various embodiments of the invention are of particular relevance to other learning applications and conditions or third-party controlled instructions or requests such as, but not limited to, those in medical rehabilitation, hospital patients, special needs children, employee, professional groups (such as accountants, doctors, and lawyers who require annual continued professional credits), specialized training courses, athletic training, physical education, military training, trivia, pre-natal care, emergency response, farming basics, sanitation and infectious disease prevention, domestic violence awareness, and so forth.

As a particular example using a patient reducing brain deterioration with customized mental exercises: A medical-dementia patient elects to use the network as a gateway where for example she informs AT&T® Inc. to enable only enable her critical communications including television satellite until after she achieves specific targets on brain exercises. She selects the education venue so that she could identify the precise elements of her brain between cognitive and pattern recognition that were further diminished. These areas then become the priority in her daily exercises. For her reward, she selects retail such as a meal at Denny's® restaurant (including senior citizen discount for mental game progress)

### Facial Recognition

In yet another instance of analytical mechanisms, facial recognition software such as programs created to track the “face print” can be incorporated into the analytical process by which a learner is engaged in a series of questions or instructions. For example, a “face print” is a series of various relative positions of various data points on a given face (e.g. nose, eyes, lips, eye brows, etc.) these different data points can be used to determine not only the face print (or the person to whom the face belongs) but the individual data points can also reveal the mood of the face (happy, sad, angry). When compared to the time to answer a question or the level of difficulty (including type of question) the tracking of the facial expression of mood would provide valuate analytical information to those familiar with the art of teaching and learning including adaptive learning. In one of many examples known to those in the level of difficulty to a question could be changed before the student even answered the question. In other words, instead of waiting for the student to submit an incorrect answer before changing the level of difficulty an adaptive program could change the reduce the level of difficulty as the expressions become more frustrated (frown) or increase the level of difficulty as the expressions become more excited (smile or laugh gesture).

### Optical Scan Analysis

Examples of common eye movement patterns include the following: Visual Construction, looking up and to the left. The person is accessing information from their imagination and might possibly be making it up; Visual Remembering-looking up and to the right. This is when the person is actually accessing a memory and picturing it in his head. Auditory Construction-looking middle and to the left. This is where a person's eyes might go if he was constructing a sound in his mind; Auditory Remembering-looking middle and to the right. This is where a person's eyes might go if he was remembering a sound that he had heard previously; Kinesthetic-looking down and to the left. This is the direction a person's eyes might go if he was accessing his actual feelings about something; and Auditory Digital-looking down and to the right. This is the direction a person's eyes might go when he is talking to himself. All of these provide a new insight that would be a powerful analytical tool to helping and end user better learn or perform the instructions.

Further still, the pupils can be observed and changes in the pupils size (dilation) can provide a new dimension into a student's learning process or an individual's behavior modification. More specifically, the size of the pupils (dilation) can indicate whether the end user is experiencing a higher (larger pupil size) or lower (smaller lower pupil size) challenge based on an optical tracker. This evidence can contribute to the learning material being introduced to the end user so it can be adjusted upward or downward (in difficulty) based on the desired learning platform.

As background, pupil dilation generally correlates with arousal so consistently that researchers use pupil size, or pupillometry, to investigate a wide range of psychological phenomena. Stimulation of the autonomic nervous system's sympathetic branch, known for triggering “fight or flight” responses when the body is under stress, induces pupil dilation. Whereas stimulation of the parasympathetic system, known for “rest and digest” functions, causes constriction. Inhibition of the latter system can therefore also cause dilation.

In one study, a scientist observed that when he instructed subjects to remember and recite a series of seven digits, their pupils grew steadily as the numbers were presented one by one and shrunk steadily as they unloaded the digits from memory. Subsequent research found that the pupils of more intelligent people (as defined by their Scholastic Aptitude Test scores) dilated less in response to cognitive tasks compared with those of lower-scoring participants, indicating more efficient use of brainpower.

### Wearable Smart Devices

Wearable smart devices, in simple terms, are attempts to free data (and other calculating aspects like movement, environmental measurements, calorie consumption, calories burned bio-monitoring, etc.) from desktop computers and portable devices. More specific examples include devices that tracks steps (and stairs) as well as sleep with a vibrating alarm, including an “optimal” wake-up window, that analyzes motion so one can be waken up during the lighter portions of his sleep cycle rather than jarring him awake in the middle of deep sleep.

Many are designed to have Bluetooth®, WiFi and GPS built in. This enables the devices to be used as standalone smart device or in combination with another smart device such as a phone, tablet, etc.

There are different companies that have already emerged with different versions of wearable smart devices and they include Fitbit® offerings, Google Glass®, Samsung Galaxy Gear®, GreenPeak® offerings, InvenSense® offerings, Lumus® offerings, Motorola Solutions® offerings, Nike FuelBand®, Vuzix® offerings and Withings® offerings.

Notable examples of commercial items that one familiar with the art would realize could be interchangeable with the traditional smart devices used such as phone, tablet, game counsel, smart tv, automobile include the products from Fitbit® Inc. and Google® Inc.

Fitbit Inc. offers several different products that include: Flex TM wireless sleep and activity tracker bracelet that tracks movement, calories consumed, sleeping, etc., Zip TM wireless activity tracker a clip on device that tracks steps, distance, calories burned, stairs climbed and sleep, Aria™ wifi weight scale (a standard home use scale configuration) that tracks weight, body mass index. Each of these devices and all of the information are sent via number of electronic methods where the information is tracked and summarized on the cloud or personal electronic device. Fitbit Inc. also offers an open API so many of the data captures can be shared and included with developments and applications.

Essentially, a Google Glass® is a camera, display, touchpad, battery and microphone built into spectacle frames so that you can perch a display in your field of vision, film, take pictures, search and translate on the go to name a few features. Bluetooth® and Wi-Fi will be built in. A user may user her Google Glass® to interact with the gateway system discussed in various embodiments. The Google Glass® and other smart devices may be locked down until targeted learning is completed. They can also provide signals that can be used to support the decision of whether a learning objective was met.

Further, the signals can be used to help contribute to important vital signs of the student or end user and that information can be used to compliment the analytic information that contributes to the “adaptive” learning. Further still, signals from devices like scales can be incorporated into the invention to help an end user learn how to better manage and understand their weight condition. For example, the instruction for an end user could be to weigh himself each morning and record the previous days physical activity and calorie consumption. Until this instruction is followed the target electronic device (or devices), with exception of scale in this case, are locked until the instruction is completed.

### “Smart” Systems for Automobiles

“Smart” car systems such as those offered by Ford Sync® include a range features that can be synchronized. To power Sync, Ford Motor Company partnered with Microsoft Corporation for the software. Microsoft Corporation created Microsoft Auto software, which can interface with just about any current MP3 player or Bluetooth® cell phone. Passengers can connect their cell phones through Sync's integrated Bluetooth technology. The software will seek the address book and transfer the names and numbers to an internal database. Like many existing Bluetooth cell phone links, Sync is capable of voice-activated, hands-free calling. Push a button on the steering wheel, and you can speak the name or number you wish to call.

Sync diverts from the traditional Bluetooth® path by utilizing text-to-speech technology to read aloud any text messages you might receive while driving. The system can translate commonly used text message phrases such as “LOL” (laughing out loud). In turn, you can reply to an audible text message from one of 20 predefined responses. Sync® also supports many of the other features found on cell phones, including caller ID, call waiting, conference calling, a caller log, and signal strength and battery charge icons. When you receive a call, Sync can play personal ring tones, including special tones for specific callers. All this information is shown on the radio display screen.

As Sync® primarily runs on software, the system is upgradeable. Ford Motor Company and Microsoft Corporation have plans to allow dealer service technicians to perform updates when the vehicles are in for scheduled maintenance. Updates may also be available on a Web-site for consumers to download and install.

Since the introduction of Sync in the 2008 model year, other car makers have launched similar systems. General Motors Company has expanded its OnStar® service and integrated Sync-like features into its infotainment system, and has even added smartphone apps so drivers can do things like unlock and start their cars remotely. Hyundai® Motor Company is launching its Bluelink® service on some 2012 models. Bluelink not only has things like vehicle tracing and crash notifications services, but also includes features like Bluetooth® integration, and location services that allow your car to check in at various locations—something that's helpful if you're a social mediafanatic.

### Lottery Style Rewards

The gateway system can include a progressive lottery type of syndicate whereby it is a linked system. In this system a group of students join into a particular type of learning or sign up for a particular type of reward that is provided by a corporate or retail sponsor. For example a group of students studying similar content for a test prep such as the SAT could all compete for a random reward. Specifically, the commonalty is the SAT content and they are each competing for a randomly generated reward. Conversely, a group of employees within a large organization with multiple locations around the world could sign up for a specific reward (such as additional vacation time, a gift certificate for coffee, etc.) regardless of their job training content. Specifically, the commonalty is not the learning content—it is the specific reward.

In another case, the students could wager their accumulated time against each other whereby a single winner (or group of winners) take all or the majority of the collective time. This could be done on an individual, class or school level including any combination of participants. The competition amongst the students could include games one familiar with motivational behavior would know and include those games based on a skill or knowledge, a physical action (like running), a physical change (like gaining or losing weight), luck (like those associated with compulsion) or game of chance or any combination.

### Global Positioning Satellite (GPS) Systems

In the case of tracing GPS coordinates, many smart devices come with a built-in GPS function. The GPS function is a byproduct of using a smart device. For example, the built-in receiver trilaterates your position using data from at least three GPS satellites and the receiver. GPS can determine ones location by performing a calculation based on the intersection point of overlapping spheres determined by the satellites and your phone's GPS receiver. In simple terms, trilateration uses the distance between the satellites and the receiver to create overlapping “spheres” that intersect in a circle. The intersection is your location on the ground. This GPS feature has been incorporated into a number of native applications and web based applications that incorporate the smart devices user's location. Examples include Groupon®, Facebook® Nearby®, and Eventseeker®. In each of the examples, the smart device user can be informed when he enters a specific set of coordinates about a particular discount at restaurant, a friend's proximity or a an entertainment event. The “GPS coordinates” demonstrates what one familiar with the art could do to enable the smart device to become a tracking beacon for periods of time that include until a target event occurs or the passage of a prescribed amount of time.

Using GPS signals, the students are identified while in a Retail store and join the contest through their electronic devices. In one embodiment each of the students is in the same location in another embodiment the students are in different locations. In another example, students can represent groups of students in classrooms or any group, such as a church group. In lieu of the GPS coordinates, the activity of the contest could include any type of membership program that could allow students or groups, to enroll and compete in the contest from remote locations, through the cloud.

The assessment and gateway functions may further comprise utilizing location based content and calculating the location of the user via, for example, the use of global positioning system (GPS) capabilities on the user's electronic computing device. The user may be required to perform a physical task (e.g. running around neighborhood, walking home from school at certain time and route) that is tracked by the user's device. Likewise, the content of the questions is location based. For example, a student walks into a math class 5 minutes before class starts and he would like to text. The gateway would be math themed questions of the day sponsored by the teacher of math questions customized to the student's current trends on tests and quizzes. And in a commercial setting, a customer at Starbucks® store or website might be asked a series of questions about the nutritional value of his most recent purchases. Further still, in an employment setting the employee may be asked a series of questions about laboratory safety or emergency exits as they move from one plant to another.

### GPS-Based Trigger for Locking and Unlocking Mechanism

The reward may be initiated by the global positioning service (GPS) of the electronic device and the relative location of the student using the electronic device. For example, in one case the student could be walking home from school and passing by a Starbucks®. At such time, as he falls with a specific boundary of the GPS coordinates relative to the Starbucks a reward potential could be activated to induce the student to learn in exchange for an immediate reward upon completing a particular learning assignment. As a simple example, the student could complete a module on his SAT prep at the Starbucks and receive an immediate reward.

In another case, a random reward could be location based where for example if a student was walking by a retail sponsor they could be informed of a particular reward. In the location based award a set of GPS coordinates would be activated such that any electronic device traveling within such GPS coordinates triggers a reward such as drop into WalMart® store for a discount or a free soda.

### GPS-Based Check-ins for Locking and Unlocking Mechanism

In another example of the invention, a third-party might require the device user on certain days of the week to (1) show up and check in to a specific location such as a school location by a certain time, (2) check in as still at school at the same location end of the school day, (3) check in at home by a certain time, (4) check in at home later in the evening to prove the user is still there. Rewards rules can be specified such as all four rules must be met for five days in a row to trigger a full allowance, or that for each check-in, $2 is accumulated into the allowance credits, or indeed, any number of other rules for rewards as described elsewhere. Each “check in session” could include specific unique learning questions or instructions that are customized to the end user to further confirm that the end user and the end user's device are in the specified coordinates requested by the third party.

### Electronic Device Usage/Credit Provided by Network Provider or Sponsor

In one scenario the student is provided a credit or full payment for their monthly service bill from their cell phone and/or cable carrier. The services that would be included would include all communications such as radio communications and satellite communications along with 2G to 4G Wi-Fi, cable and combinations as well. In a further example, the student is provided an electronic device and each day he earns time to access the features on the device in exchange for achieving targeted learning objectives. In a specific example, an at-risk child could be provided an electronic device and each incremental period such as a 24 hour period, a specific amount of learning content such as that related to the GED (general education diploma) would require a level of mastery in exchange for using the device for the incremental period. Further still, the results could be reported to third-party such as a sponsor or teacher or both.

### Anti-Cheating Mechanism

An electronic device could be programmed with a motion detection sensor such that the user has to keep both hands on the phone. In one case he would have his left hand under the phone and his right hand held against the home screen while he calculates the answer in his head. In other words, an intent of the anti-cheating is to prevent the user from going to another device, such as a calculator or a friends smart device to solicit the answer. If an unauthorized motion is detected then a new instruction or question could be generated. In another instance of anti-cheating mechanisms an optical tracking software such as the programs created by Tobii Technology®, Inc. or the eye tracking software from Samsung Group® in their Android 4.2 version. Using optical tracking if the user takes his eye off or away from the screen for a preset time such as 3 seconds then another instruction or question would be created for example.

In each case of an expected act of cheating, the result could be an immediate suspension of use, limited accessibility, reduced time, time subtracted, etc. These are only a few examples of how one familiar with the art of teaching and electronic device detection features would include in an anti-cheating mechanism.

### Compulsion Loop

Researchers and scientists are frequently publishing reports that refer to the new levels of addiction to electronic entertainment. For example, one study of more than 1,000 students from 10 countries and 12 universities concluded that the majority were not able to voluntarily forego their electronic connections for a mere 24 hours. In particular, the study found that these college students admitted to being “addicted” to modern technology such as mobile phones, laptops and television as well as social networking such as Facebook® and Twitter®.

Functional magnetic resonance imaging (fMRI) was used, in another study, to visualize which parts of the brain were engaged during certain aspects of social media. The overall conclusions were that the use of social media, and in particular expressing one's owns opinion, positively triggers dopamine reward pathways. The researchers even determined that many of the subjects would prefer reporting their own experiences to receiving a monetary reward.

Similar indications were noted in certain video gaming, which introduce high levels of “randomness” in reward granting as an intentional means of forming an addiction. The idea dates back decades and its used to create a compulsion loop that keeps the player engaging in the activity. The technique is referred to as the variable ratio of reinforcement (or operant conditioning). It is considered simple and powerful and is believed to be one of the reasons gambling is so addictive. This trend of operant conditioning has also led to a number of allegations that emailing possesses addictive characteristics. In fact, a new term of “emailoholics” emerged as the result of one author's studies. In this regard, using a random nature of rewards would entice the end users or students to engage in the invention. Further, having a system that enables a range of different reward types and levels is a targeted objective of this invention as well.

### Captive Marketing and Advertising

While the user is locked out of his phone (or electronic device) or participating in a contest while trying access to his phone, advertisers including the retailers have a captive audience for a host of different advertising options to those familiar with the art of on-line advertising and marketing on the world wide web. In one instance, the advertiser could use a retailers name in the form of the various questions, such as if one mocha from a Retailer costs $2.00 and a customer purchases five mochas, how much will the customer spend is an example of a question. Alternatively, if the Retailer's rewards card has $50.00 credit and a customer spends $17.50 what is the balance on the rewards card is another example of a question. Alternatively, banner adds could be placed or other features such as the mathematics content is brought to you a particular Retailer.

A critical feature of the locking mechanisms is the creation of a unique opportunity for targeted marketing that is used directly or indirectly with education, instruction or contest material. In such a case, advertisers would compensate the hosting cloud (or network) who is coordinating the introduction of the marketing material into the education content directly (or any parties working indirectly together or in combinations) as part of the question or as a separate advertisement. In yet another embodiment of the invention the separate advertisement may be accessible directly or only after another question or series of questions is generated on the display of the electronic device. Further still, the advertisers could rely on the nature of the content of the questions for the demographics of the targeted end user providing both a captive audience in combination with a demographically focused end user or group of end users. This example of a system and method of captive marketing and advertising is not limited to only these examples rather it is illustrative of one aspect of the current invention. The captive marketing mechanism could be integrated into each of the examples and illustrations included herein by one familiar with the relevant art.

In such a case, advertisers would compensate a hosting software who is coordinating the introduction of the marketing material into the education content directly as part of the question or as a separate advertisement. In yet another embodiment of the invention the separate advertisement may be accessible directly or only after another question or series of questions is generated. Further still, the advertisers could rely on the nature of the content of the questions for the demographic of the targeted user providing both a captive audience along with a demographically focused. This discussion of captive marketing in not limited to these examples rather it is illustrative of one aspect of the current invention.

The reward feature may be further exemplified and enhanced by the type of reward trigger, the reward types, the rewards redemption, reward gamesmanship, and reward providers. Below are specific examples of each and demonstrate the various types of individual activities that one familiar with the art could incorporate.

Rewards Triggers include: check-in at certain places such as school, third-party school reporting, extracurricular conditions/goals, completion of chores, school attendance, homework completion, direct teacher third party reporting, API to teacher server for tracking grades, API to school hosting server, accomplishing specified blocks of educational content, exposure to certain blocks/time periods of learning content (video, audio, ebook), incentives for study groups/studying content together with device users, group contests, educational content, extracurriculars—outside contests that specify device user(s) as meeting, criteria, and allot those rewards to qualifying user id's for redemption

Rewards Types include: Cumulative allowance credit, activated in portions for continued performance of criteria rules, Periodic allowance credit activated periodically for fulfilling minimum conditions, Third Party bestowal and third party can immediately bestow through portal for arbitrary things (mowing lawn, polite behavior, etc.).

Rewards Redemption include: partnership with Square®, Inc. and/or other mobile payment apps/companies, partnership with credit card company—puts money right on a debit card credits stored as data which work toward participating partner programs, partnerships with vendors/sponsors, and programs/contests at school or other third parties

Rewards Gamesmanship include: students can double down (or specified extra reward) with rewards by completing extra credit education content, students can risk losing x and stand to gain y, by attempting harder extra credit, question(s) which proved an A+ level of excellence in learning the material, a special Third Party at any “real life” gamesmanship can be designated to be, the “decider” of an award or contest, for example, for a sprint, or a talent, show, and immediately bestow the award to the user via their user id to a portal or directly using his device and the user's device through application on each device using NFC or QR code or what not.

Rewards Providers include: Vendors, Schools/institutions and Third Party (parent)—selects a goal such as bicycle, wherein transaction using THEIR credit card gets unlocked by meeting rewards triggers/criteria. One familiar with the art would understand how these can be incorporated into the various reward features illustrated elsewhere in this document.

### Toys and Other Devices

The features discussed in various embodiments may also be used in conjunction with existing interactive toys and robots. For standalone toys and robots, and other electronic computing devices that are not connected to a network, the educational software is installed on the device, toy, or robot and coded to be compatible with the specific device and any other computer software associated with it. As a result, the user would have to successfully execute the testing modules of the present invention in order to gain access to the device, toy, or robot. And for interactive toys, robots, and other electronic computing devices connected to a network, the Educational software is downloaded to the device, toy, or robot, or accessible via the Question & Answer (Q & A) system server; and is coded to be compatible with the specific device, toy, or robot and any other software associated with it (e.g. toy mobile app). In other instances the interactive toys can be turned off by failing to complete the targeted objectives or the interactive toys level of interaction can be based on the advancement of the learning modules within the framework of this invention.

The features discussed in various embodiments can be integrated into these “smart” features in the car and will thusly disable the features in the car directly through the target electronic devices or into the separate software of the vehicle using API or other means well known to those in the art.

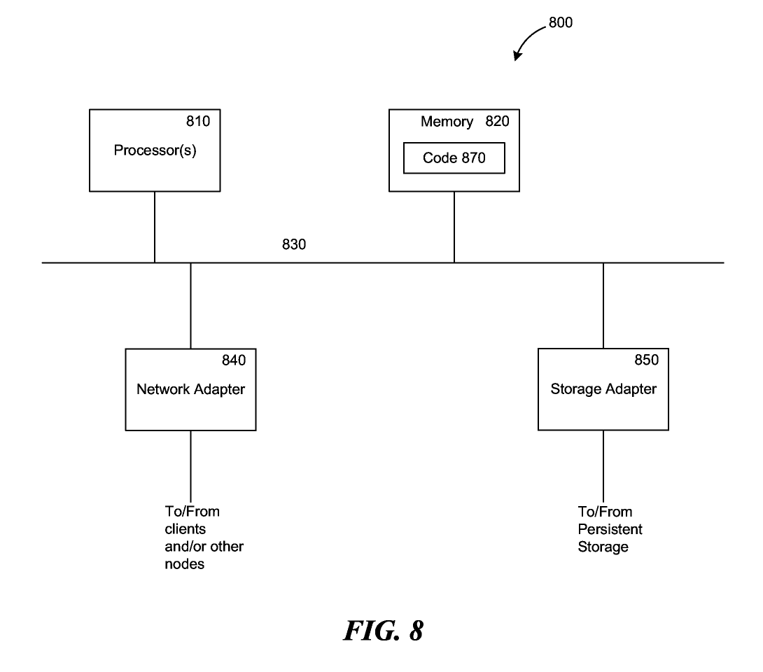

FIG. 8 contains a high-level block diagram showing an example architecture of a computer, which may represent any electronic device, any server, or any node within a cloud service as described herein. The computer 800 includes one or more processors 810 and memory 820 coupled to an interconnect 830. The interconnect 830 shown in FIG. 8 is an abstraction that represents any one or more separate physical buses, point to point connections, or both connected by appropriate bridges, adapters, or controllers. The interconnect 830, therefore, may include, for example, a system bus, a Peripheral Component Interconnect (PCI) bus or PCI-Express bus, a HyperTransport or industry standard architecture (ISA) bus, a small computer system interface (SCSI) bus, a universal serial bus (USB), IIC (12C) bus, or an Institute of Electrical and Electronics Engineers (IEEE) standard 1394 bus, also called “Firewire”.

The processor(s) 810 is/are the central processing unit (CPU) of the computer 800 and, thus, control the overall operation of the computer 800. In certain embodiments, the processor(s) 810 accomplish this by executing software or firmware stored in memory 820. The processor(s) 810 may be, or may include, one or more programmable general-purpose or special-purpose microprocessors, digital signal processors (DSPs), programmable controllers, application specific integrated circuits (ASICs), programmable logic devices (PLDs), field-programmable gate arrays (FPGAs), trusted platform modules (TPMs), or the like, or a combination of such devices.

The memory 820 is or includes the main memory of the computer 800. The memory 820 represents any form of random access memory (RAM), read-only memory (ROM), flash memory, or the like, or a combination of such devices. In use, the memory 820 may contain code 870 containing instructions according to the techniques disclosed herein.

Also connected to the processor(s) 810 through the interconnect 830 are a network adapter 840 and a storage adapter 850. The network adapter 840 provides the computer 800 with the ability to communicate with remote devices over a network and may be, for example, an Ethernet adapter or Fibre Channel adapter. The network adapter 840 may also provide the computer 800 with the ability to communicate with other computers. The storage adapter 850 allows the computer 800 to access a persistent storage, and may be, for example, a Fibre Channel adapter or SCSI adapter.

The code 870 stored in memory 820 may be implemented as software and/or firmware to program the processor(s) 810 to carry out actions described above. In certain embodiments, such software or firmware may be initially provided to the computer 800 by downloading it from a remote system through the computer 800 (e.g., via network adapter 840).

### CONCLUSION

The techniques introduced herein can be implemented by, for example, programmable circuitry (e.g., one or more microprocessors) programmed with software and/or firmware, or entirely in special-purpose hardwired circuitry, or in a combination of such forms. Software or firmware for use in implementing the techniques introduced here may be stored on a machine-readable storage medium and may be executed by one or more general-purpose or special-purpose programmable microprocessors.

In addition to the above mentioned examples, various other modifications and alterations of the invention may be made without departing from the invention. Accordingly, the above disclosure is not to be considered as limiting, and the appended claims are to be interpreted as encompassing the true spirit and the entire scope of the invention.

The various embodiments are described above with reference to flowchart illustrations and/or block diagrams of methods, apparatus (systems) and computer program products. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

A “machine-readable storage medium”, as the term is used herein, includes any mechanism that can store information in a form accessible by a machine (a machine may be, for example, a computer, network device, cellular phone, personal digital assistant (PDA), manufacturing tool, any device with one or more processors, etc.). For example, a machine-accessible storage medium includes recordable/non-recordable media (e.g., read-only memory (ROM); random access memory (RAM); magnetic disk storage media; optical storage media; flash memory devices; etc.), etc.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The aforementioned flowchart and diagrams illustrate the architecture, functionality, and operation of possible implementations of systems, methods and computer program products according to various embodiments. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

Although various features of the invention may be described in the context of a single embodiment, the features may also be provided separately or in any suitable combination. Conversely, although the invention may be described herein in the context of separate embodiments for clarity, the invention may also be implemented in a single embodiment.

Reference in the specification to “some embodiments”, “an embodiment”, “one embodiment” or “other embodiments” means that a particular feature, structure, or characteristic described in connection with the embodiments is included in at least some embodiments, but not necessarily all embodiments, of the inventions.

It is to be understood that the phraseology and terminology employed herein is not to be construed as limiting and are for descriptive purpose only.

It is to be understood that the details set forth herein do not construe a limitation to an application of the invention.

Furthermore, it is to be understood that the invention can be carried out or practiced in various ways and that the invention can be implemented in embodiments other than the ones outlined in the description above.

It is to be understood that the terms “including”, “comprising”, “consisting” and grammatical variants thereof do not preclude the addition of one or more components, features, steps, or integers or groups thereof and that the terms are to be construed as specifying components, features, steps or integers.

I/we claim:

1. A method performed by a gateway server which runs on or is connected to a cloud-computing platform, comprising:
receiving a request for a reward from a client device of a user which is connected to the cloud-computing platform;
selecting one or more tasks based on a preset objective for the user and a current performance level of the user;
transmitting one of the selected tasks to the client device;
receiving a task performance result from the client device;
evaluating the received task performance result against an expected task performance result for the transmitted task;
determining whether the evaluation meets the preset objective;
when the determination result is positive, selecting a reward for the user based on a preference of the user; and
delivering the selected reward to the client device.

2. The method of claim 1, further comprising sending a request for the one or more tasks to and receiving the one or more tasks from an assessment system which is connected to the cloud-computing platform.

3. The method of claim 2, wherein the assessment system is operated by an academic institution or an education agency.

4. The method of claim 1, further comprising sending a request for the selected reward to and receiving the selected reward or information on receiving the selected reward from a reward system which is connected to the cloud-computing platform.

5. The method of claim 4, wherein the reward system is operated by a retailer, a social media manager, or a financial institution.

6. The method of claim 1, wherein evaluating the received task performance result against an expected task performance result for the transmitted task includes sending the received task performance result to and receives an evaluation of the received task performance result against an expected task performance result from an assessment system which is connected to the cloud-computing platform.

7. The method of claim 1, wherein the client device is a smart mobile device.

8. The method of claim 1, wherein the requested reward is an authorization of access by the user of features or functions of the client device, and the delivered reward is the same as the requested reward.

9. The method of claim 8, wherein the features or functions of the client device include making phone calls, visiting websites, sending email or chat messages, playing games, and performing social-media activities.

10. The method of claim 1, wherein the transmitted task is answering one or more questions in a subject matter and the expected task performance result for the transmitted task is answering at least a certain number of the questions correctly.

11. The method of claim 10, wherein the preset objective is receiving at least a certain grade in a test for the subject matter.

12. The method of claim 1, wherein the user is a student, and the preset objectives are related to the student's attendance, academic performance, extracurricular activities, and general conduct in school.

13. The method of claim 1, wherein the objective is preset by a third party who is different from the user.

14. The method of claim 13, wherein the user is a student, and the third party is a parent or a teacher of the student.

15. The method of claim 13, wherein the user is an employee, and the third party is an employer of the employee.

16. The method of claim 13, further comprising informing the third party of the task performance result and the corresponding evaluation.

17. The method of claim 1, further comprising, when the determination result is negative, transmitting another of the selected tasks to the client device.

18. The method of claim 1, wherein selecting one or more tasks is further based on a current time or a user's location.

19. The method of claim 1, wherein selecting a reward for the user is further based on a preference of a third party, a current time, or a user's location.

20. The method of claim 1, where the delivered reward is predetermined by a third party who is different from the user.

21. The method of claim 1, wherein the gateway server is operated by a network service provider, and the steps are performed as a service agreement between the network service provider and a third party purchasing the service agreement for the user.

22. The method of claim 1, wherein the gateway server is operated by a manufacturer of the client device, an academic institution attended by the user, or an education agency providing services to the user.

23. The method of claim 1, further comprising delivering the requested reward to the client device without selecting any task, wherein the received request includes an override instruction.

24-28. (canceled)
